(19) United States
(12) Patent Application Publication
(10) Pub. No.: US 2018/0244141 A1
(43) Pub. Date: Aug. 30, 2018

(54) RETRACTABLE TIRE AWNINGS AND RELATED METHODS

(71) Applicant: Girard Guard, LLC, San Clemente, CA (US)

(72) Inventors: Johnnie Michael Mathiasen, San Clemente, CA (US); Oscar Solis Marquez, San Clemente, CA (US)

(21) Appl. No.: 15/755,977

(22) PCT Filed: Aug. 26, 2016
(86) PCT No.: PCT/US2016/049142

§ 371 Date: Feb. 27, 2018

Related U.S. Application Data
(60) Provisional application No. 62/211,615, filed on Aug. 28, 2015.

(51) Int. Cl. B60J 11/10; B62D 25/18

(52) U.S. Cl. CPC B60J 11/10; B62D 25/182

(57) ABSTRACT

Tire awning or tire shade assemblies, components thereof, and methods for making and using the tire awning assemblies are disclosed. Exemplary awning assemblies include a cassette having a plurality of panels, a tube received in the cassette, a shade wound around the tube having a free end extending out a bottom panel of the cassette in a deployed position to provide shades from UV rays, and optional weight coupled to the free end of the shade to assist with retracting the shade.

### FIELD OF ART

The disclosed invention generally relates to retractable awnings and more specifically directed to retractable awnings and related methods for use with vehicles, such as recreational vehicles, utility vehicles, or trailers, to provide shade for the tires. Utility vehicles can include ambulances, fire trucks, and military vehicles.

### BACKGROUND

Vehicles typically kept or stored outdoors may be exposed to damage from the environment. Extended exposure to direct sunlight is one environmental hazard that can reduce the usable life of a tire before the tread-life of the tire is sufficiently worn. UV rays and heat from the sun can shorten the life of rubber tires by causing the tires to weather crack and dry rot, especially when not in use. Shielding tires from the sun using tire covers can protect the tire from UV rays. Each tire cover can be manually placed directly over an individual tire by hooking over the back of the tire. However, placing the tire cover over the tire is time consuming and can be difficult to properly install without additional help or getting dirty. Furthermore, the tire cover is sized according to the size of the tire.

### SUMMARY

Aspects of the present disclosure include a tire awning assembly or tire shade assembly. The tire awning assembly can be sized and shaped to provide shade for a tire. The tire awning assembly can be extendable or retractable to cover or to expose a tire, respectively. The tire awning assembly can be extended or retracted manually, automatically, or semi-automatically.

In an example, a tire well or wheel well of a vehicle has a width W and wherein a width of the tire awning assembly is W+Y, wherein Y can be zero (0) and up to about 12 inches. In other examples, Y can be larger than 12 inches. A tire awning assembly can be mounted adjacent or near a wheel well.

An exemplary tire awning assembly can include one or more brushes, a tube, and a shade wound around the tube slidably inserted into a housing or cassette having opposite open ends. The brushes can be configured to brush dust or debris from the shade as the shade expands and rolls around the tube. A pair of end plates or caps can be attached to the open ends of the cassette to complete closure of the cassette and secures the shade, the tube, and the pair of brushes inside the cassette.

Attached to a free end of the shade can be a shade rod. The shade rod can provide weight to assist drawing the shade from out of the cassette. The shade can have any number of patterns and/or colors. Any number of art work, logos, or designs can be provided on the shade for aesthetic appeal. Text or words can be included and can be customizable.

The shade rod can be coupled to a weighted bottom plate by a swivel cover, which can be attachable to an end of the bottom plate. There can be two swivel covers, one on each end of the bottom plate.

The bottom plate can be pressed against or spaced adjacent to a bottom panel of the cassette in the retracted position with the swivel cover partially extended into the debris brush chamber.

The cassette can have a mounting panel adjacent to and connected to the bottom panel, and a cover panel connected between the mounting panel and the bottom panel.

The cassette can have a long and slender hollow shape, but other shapes are contemplated to accommodate various mounting surfaces of the vehicle.

The cassette can be made of a durable lightweight material such as a hard plastic or a metal such as aluminum.

The cassette can be extruded. For example, the cassette can be made from extruded aluminum.

The tire awning assembly of the present disclosure can be factory mounted or provided as an after-market product for mounting by end-users or mechanics.

The tire awning assembly may operate in all weather conditions. The cassette can be structured to withstand moisture and debris striking the cassette when the vehicle is moving or parked.

Three separate chambers may be formed inside the cassette including a shade chamber, a brush chamber between the shade chamber and the bottom panel, and a mounting chamber between the shade chamber and the mounting panel. The shade and the tube can be received in the shade chamber, and the brushes can be received in the brush chamber.

The open ends of the cassette may have a plurality of attachment holes to receive fasteners passing through holes of the end plates to fasten the end plates to the cassette.

The attachment holes at each open end may be tapped holes or fitted with inserts to receive the fasteners. Alternatively, the holes may be female detents to receive male detents extending from the end plates.

A mounting slot can extend longitudinally across the mounting panel into the mounting chamber from one open end towards the other open end to provide access to the mounting chamber. The mounting chamber may be isolated from the shade chamber and the brush chamber to prevent or limit debris and moisture that may enter through the mounting slot into the mounting chamber from entering the other chambers.

A mounting protrusion extending from a vehicle may slide inside the mounting chamber along the mounting slot from one open end to support and fix the tire awning assembly to the vehicle.

The mounting protrusion can be an L-shaped or a T-shaped protrusion extending from a bracket mounted on the side of the vehicle. The T-shaped or L-shaped protrusion can have a center portion extending from the bracket through the mounting slot and a cross member extending transversely from the center portion.

A coupling clip or channel may join the cassette to the vehicle without or in addition to a male projection and slot type attachment.

The tire awning assembly may be assembled to the vehicle by sliding the mounting protrusion through one open end.

The center portion can slide along in the mounting slot and the cross member can slide inside the mounting chamber and engage with one or more interior surfaces of the mounting panel.

Any gaps between the center portion and the mounting slot and/or between the cross member and the interior surface of the mounting panel can be minimized to prevent the tire awning assembly from rattling and shifting when mounted to the vehicle.

Springs, Belleville washers, or spring washers may be used throughout the assembly to ensure adequate biasing and loading to minimize or prevent rattling and loosening.

In one example, the mounting protrusion may form a seal with the mounting slot. With the mounting protrusion fully engaged with the mounting panel, the end plates can be attached to the open ends to capture the mounting protrusion inside the mounting chamber and the mounting slot.

The length of the mounting protrusion may also be as long as the mounting slot to prevent side by side movement between the tire awning assembly and the mounting protrusion.

The tire awning assembly may also be attached to the vehicle by other attachment means. In one such example, the tire awning assembly may be attached to the surface of a vehicle using magnets positioned in the mounting chamber to magnetically attach to the sheet metal of the vehicle. In other examples, the magnets can be located on the vehicle, or both the mounting chamber and the vehicle and can be assisted with fasteners.

The bottom panel can be adjacent to and substantially perpendicular to the mounting panel. A longitudinal slit can extend between the shade chamber and the brush chamber from one open end to the other open end. A cassette opening can extend longitudinally across the bottom panel from one open end towards the other open end below the longitudinal slit.

The shade can extend from the shade chamber through the slit into the debris brush chamber and through the cassette opening to exit the cassette. The cassette opening and the slit can each have a width at least greater than a thickness of the shade and a length at least greater than the width of the shade so that the shade may slide through the cassette opening and the slit without or with only minimal restrictions.

The brush chamber can house and support the pair of brushes, which can slide into the brush chamber from one of the exposed ends of the cassette. Each brush can comprises a base and a plurality of bristles extending from the base. The brush chamber may be sized and shaped to retain and prevent the brushes from jostling or moving around inside the debris brush chamber. A width of the brush may be larger than the width of the cassette opening to prevent the brush from slipping out the cassette opening. In other words, a slight interference may be provided to ensure adequate retention of the brushes within the chamber. Inside the brush chamber, the pair of brushes can be aligned between the cassette opening and the slit with the bristles extending towards each other from the bases. The pair of brushes may also be integrally formed or attached together to form a single unit. The bristles can press against the shade to remove debris, such as dirt and dust from the shade as the shade is drawn up into the shade chamber through the cassette opening and the slit.

The shade may be made of a flexible material to be wound around the tube in a stowaway position and provide cover or shade for the tire when unwound from the tube. In one example, the shade can be made from acrylic or canvas. The material or construction of the shade can block UV rays from penetrating through the shade and onto the tire. In one example, the shade can block at least 50% of the UV rays from penetrating through the shade.

A coating may be applied to the shade to increase the blocking effectiveness of the shade in blocking the sunlight and UV rays. The shade can have an attached end along a width of the shade which can be attached to an outer circumference of the tube by adhesive, tape, or other attachment means, such as threads.

With the attached end attached to the outer circumference, the shade can be wrapped around the tube. The number of wraps around the tube can depend on a length of the shade and the circumference of the tube.

The tube can be cylindrical having a hollow bore. At a free or loose end of the shade, a shade rod receptacle can accommodate the shade rod.

The shade rod receptacle can be formed by forming a small U-shaped bend and fastening or sewing the loose end of the shade back to another section of the shade to create a loop sized for the shade rod to slide and remain in place.

The tube can reside in the shade chamber with the shade extending through the slit and between the bristles of the pair of brushes. The shade rod can be received in the shade rod receptacle.

The shade rod can be smaller than the width of the cassette opening to allow the shade rod to enter the brush chamber through the cassette opening, but larger than the width of the slit to prevent the shade rod from entering the shade chamber from the brush chamber. In another embodiment, the slit can be larger than the shade rod so that the shade rod can enter into the shade chamber.

The shade rod can be coupled to the bottom plate by the swivel cover. The swivel cover can have a first hole to receive and secure the shade rod to the swivel cover and one or more second holes that may be used to fix the swivel cover to the bottom plate. Fasteners can extend through the second holes and engage the engagement holes in the bottom plate to attach the swivel cover to the bottom plate.

The swivel cover can allow the bottom plate to rotate with respect to the shade rod for easy closure in the retracted position.

With the bottom plate coupled to the shade through the swivel cover and the shade rod, the bottom plate may provide the necessary weight heavy enough to pull or assist the shade to unwind from the tube, thereby rotating the tube in an unwinding direction, under the force of gravity to a deployed position or to an extended position between the retracted and deployed position.

The shade can cover or provide shade for one or more tires of the vehicle when in the extended position or deployed position. In some examples, the shade can be larger than a tire for a particular wheel well. In other examples, the shade can be larger than the wheel well, at least along the width of the wheel well.

The extension of the shade outside the cassette can be controlled by rotation of the tube of which the shade is attached. For example, the shade may be drawn up or retracted into the cassette by rotation of the tube inside the shade chamber in a winding direction.

The shade may be drawn out of the cassette by rotation of the tube in an unwinding direction opposite the winding direction by the weight of the bottom plate under gravity. The bottom plate can also act as a handle to manually pull the shade to unwind the shade from the tube to the extended or deployed position. A motor may also be used to deploy the shade.

To return the tire awning assembly to the retracted or stowaway position, the shade can be rolled back up into the cassette by rotating the tube in the winding direction until the bottom plate is pressed against the bottom panel thereby covering the cassette opening. This can be accomplished by the motor or a spring roller.

The bottom plate can form a seal against the cassette opening to prevent dust, debris, or moisture from entering the brush chamber in the retracted position. The bottom plate may be a flat plate with enough mass to pull the shade and unwind the tube under the force of gravity. However, the weight can be less than that and additional pulling or tugging by a user can further unwind the shade.

The shade rod can seat against the slit and form a seal between the slit in the retracted position.

With the tube, the shade, and the brushes in the cassette, the end plates may be attached to the open ends of the cassette to secure the components in the cassette. Additional components may be added or substituted in the tire awning assembly such as components for a motorized tire awning assembly or a non-motorized tire awning assembly.

Another aspect of the present disclosure includes the tire awning assembly, which can comprise a cassette, a tube, shade wound around the tube, a motor coupled to the tube, a battery electrically connected to the motor, a shade rod attached to a free end of the shade, a bottom plate coupled to the shade rod by a swivel cover, a pair of brushes received in a brush chamber of the cassette, and a pair of end caps.

The motor can comprise a motor head anchored to the cassette, at or near one of the ends that can be designated as a motor bracket. The motor can have a rotatable shaft and a motor adapter connected to the shaft to be rotatable thereby and relative to the motor head. The motor can be a conventional AC or DC powered motor with sufficient horse power and torque to rotate the tube to rotate the shade.

The motor adapter can be fitted inside the bore of the tube to rotate the tube when the motor is activated. The motor can be operated remotely or the cassette can be equipped with a controller and switch locally to activate the motor. The motor adapter may be press fitted inside the bore and/or aligned with a key such as protrusions or grooves of the bore engaging with complementing grooves and protrusions of the motor adapter to control rotation of the tube in the winding direction and/or the unwinding direction opposite the winding direction.

The motor adapter and the bore may also incorporate gears so that the motor adaptor can rotate the tube through gearing. A roller or guide may be fitted onto the opposite side of the tube to align the tube in the shade chamber and allow the tube to rotate freely in either direction.

The motor can draw power from the vehicle battery, such as 12 VDC, or an external or separate battery housed within the cassette and electrically connected to the motor. The battery may be received inside the bore or disposed in the mounting chamber. The battery may also be a rechargeable battery electrically connected to both the vehicle battery to recharge the battery while supplying power to the motor. The battery may also optionally be charged by photocells, which can be mounted somewhere external of the vehicle, such as on the roof thereof. In one example, the power requirement of the motor is about 6.7 Watts which would draw about 0.6 Amps with a retraction speed of about 34 rpm.

Before the motor can be activated to rotate the tube, the motor head can be anchored to the cassette so that the motor adapter can rotate relative to the motor head. The motor head may have a non-circular shape matching a similar shaped cutout (not shown) in an internal surface of the end cap to receive the motor head, thereby anchoring the motor head to the end cap. The non-circular shapes of the motor head and cutout in the cap provide interference from rotation. Because the end cap can be fixed to the open end of the cassette, the motor head can be also deemed fixed to the cassette.

The motor head can be securely fastened to the end cap by securing fasteners extending through the end cap and engaging with tapped holes or inserts in the motor head.

The end cap or end plate may further include a pocket at an external surface of the end cap so that screw heads or nuts for threading to the securing fasteners, such as to threaded float rods or threaded rods, to secure the motor head of the motor to the end cap can reside inside the pocket.

A hiding cover or finishing cover can then be attached to the external of the end cap over the pocket to hide the heads or nuts and present a smooth and/or aesthetic appearance.

When the motor is activated, the motor adapter can be configured to rotate the tube in the winding direction to wrap the shade around the tube, thereby drawing the shade into the cassette from an extended or fully deployed position.

The motor can be controlled remotely or directly on the tire awning assembly by a switch, such as a remote wall switch or key, or a switch or key directly on the tire awning assembly. Once a desired position is reached, such as in the retracted position, power to the motor can be cut. After power to the motor is cut, brakes on the motor may hold the tube in any position thereby preventing the tube from rotating in the unwinding direction from the weight of the bottom plate under gravity. Thus, the length of shade exposed from the cassette can be controlled by operation of the motor.

To extend the shade, the motor brakes can be released to allow the tube to rotate in the unwinding direction and the shade to deploy from the cassette to the desired position by the weight of the bottom plate. The motor may also rotate the tube in the unwinding direction to unroll the shade from the tube in addition to the weight of the bottom plate. Thus, the length of shade deployed from the cassette may be adjusted by operation of the motor in both the winding and unwinding directions until the desired length is obtained.

Another aspect of the present disclosure includes a tire awning assembly, which can comprises a cassette, a tube, a shade wound around the tube, a spring roller fitted inside a bore of the tube, a spring adjustment plate, a bushing, a shade rod attached to a free end of the shade, a bottom plate coupled to the shade rod by a swivel cover, a pair of brushes comprising bristles received in a brush chamber of the cassette, and a pair of end caps attached to the cassette.

The spring roller can comprise a housing and a pin rotatably coupled to the housing. The housing can be fixed in the bore of the tube by interference fit and/or aligned with a key, such as protrusions or grooves of the bore engaging complementing grooves and protrusions of the housing.

The spring roller mechanism can operate by rotation of the housing with respect to the pin. When either the pin or the housing rotates with respect to the other, a spring inside the spring roller can also rotate and become continuously tighter as the rotation continues. Said differently, as the housing rotates relative to the pin, elastic energy can be stored within the spring to rotate the housing back from where it was rotated. Also located within the spring roller is a catch mechanism that can hold the spring during the rotation.

Before the spring roller can rotate the tube, the pin can be anchored to the cassette. The spring adjustment plate can have a ridged circumference and a protrusion extending from a center of the adjustment plate. The pin can have a noncircular shape engaging a similarly shaped receptacle in the protrusion to prevent the pin from rotating with respect to the spring adjustment plate.

The pin can be flat or rectangular and engages a rectangular receptacle in the protrusion. The ridged circumference can engage a complementing circular ridge formed in the end plate. The ridged circumference can allow the spring adjustment plate to be rotated at various angles to accommodate the angle of the pin, which is to engage in the receptacle. For example, if the rectangular pin is at a 45 degree angle with respect to the bottom panel, then the adjustment plate may be rotated along the ridged circumference until the angle of the receptacle is also at a 45 degree angle with respect to the bottom panel.

A greater number of ridges of the ridged circumference allows for a finer adjustment. In some examples, the spring adjustment plate may not have a ridged circumference but can be directly fixed to the end plate to anchor the pin to the end plate.

The protrusion may also be noncircular and engage the bushing having a matching noncircular bore to receive the protrusion. This can allow the bushing to rotate with the protrusion and stay attached to the protrusion. The protrusion can extend through a through hole in the end plate and the bushing until the pin engages the receptacle, thereby anchoring the pin to the end plate which can be fixed to the cassette.

The shade of the non-motorized tire awning assembly may be deployed by a user grasping the bottom plate and pulling the shade out from the cassette, thereby rotating the tube and the housing in the unwinding direction.

When the tube is rotated, the housing can be rotated to generate elastic energy stored in the spring. The more the tube rotates in the unwinding direction, the greater the elastic energy can be stored to rotate the tube in the winding direction.

The user may pull the shade from a retracted position to a fully deployed position or a position between the retracted to the fully deployed position. When the desired position is obtained, the user can release the bottom plate and a catch mechanism inside the spring roller can maintain the shade at the desired position.

If the user wants to retract the shade slightly or back to the retracted position, the user can tug on the bottom plate, which can release the catch mechanism and the elastic energy stored in the spring thereby causing the tube to rotate in the winding direction and drawing the shade into the cassette.

The tire awning assembly can be shown in the deployed position. As previously described, the bottom plate may act as a weight to maintain the shade at an extended position and ensure the shade is stretched to provide maximum shade.

The tire awning assembly can be mounted on a recreational vehicle above the tire wheel well, or on any wheeled vehicle to provide shades to any wheel well.

The tire awning assembly may be permanently or detachably mounted to the vehicle to provide cover for one or more tires of the vehicle from UV ray exposure when the vehicle is parked.

The tire awning assembly can be mounted anywhere above the tire such as inside or above the wheel well of the vehicle. In one embodiment, the tire awning assembly can be mounted above the wheel well and the tire on an outer surface of the vehicle. In another embodiment, the tire awning assembly can be mounted above the wheel well and the tire on an inside a surface of the vehicle with only a portion of the tire awning assembly exposed.

The tire awning assembly can be operated manually or motor operated, remotely, wirelessly, or directly. The size of the tire awning can vary depending on how many tires the tire awning assembly is to shield and the width of the wheel well. In one example, the tire awning assembly is about 48 inches long, about 3 inches wide, and about 2.5 inches tall in a closed state. In an extended state, the height of the tire awning assembly including the height of the cassette and the length of the drawn out shade can be about 48 inches tall. However, the size of the tire awning assembly is not limited and may change according to a size of the tire and the number of tires the tire awning assembly will cover and the dimensions provided are exemplary only.

Another aspect of the present disclosure includes a retractable tire awning assembly or a tire shade assembly to provide shade for a tire on a vehicle, which can comprise a cassette having a mounting panel, a bottom panel connected to the mounting panel, and a cover panel connected to the mounting panel and the bottom panel. The tire awning assembly can further include a tube received in the cassette, a shade wound around the tube having a free end extending out the bottom panel of the cassette in a deployed position to at least partially block the tire from UV rays, and a weight coupled to the free end and abutting against the bottom panel in a retracted position.

The free end can have a shade rod receptacle, and a shade rod received in the free end.

A swivel cover can couple the shade to the weight.

A pair of debris brushes can be received in the cassette, with each pair of debris brushes comprising bristles pressing against the shade to prevent dust and debris from entering inside the cassette.

End plates can attach to open ends of the cassette to secure the shade, the tube, and the pair of debris brushes inside the cassette.

A motor can be received in a bore of the tube. A battery can be electrically connected to the motor having a motor head anchored to the cassette and a motor adapter rotatable relative to the motor head and fixed to the bore of the tube.

The motor head can be fixed to an interior surface of one of the end plates.

The interior surface of the one of the end plates can have a recess having a shape similar to a shape of the motor head, with the motor head being received in the recess.

Fasteners can extend through holes of the end plates and engage with the motor head to fix the motor to the end plate.

A battery of the vehicle can charge the battery pack and power the motor.

The shade is extended out from the cassette by gravity acting on the weight. The tube can rotate in an unwinding direction as the shade is withdrawn from the cassette.

The motor can rotate the tube in a winding direction, the winding direction being opposite the unwinding direction.

A spring roller can be received in a bore of the tube, the spring roller comprising a housing fixed to the bore and a pin rotatably coupled to the housing and fixed to the cassette.

The pin can be fixed to one of the end plates, which can have a spring adjustment plate and a protrusion extending from a center of the spring adjustment plate engaging with the pin to fix the pin to the spring adjustment plate.

The pin can be rectangular shaped and the protrusion can have a rectangular shaped recess receiving the pin.

The spring adjustment plate can have a ridged circumference corresponding to a ridged structure on the end plate to fix the spring adjustment plate to the end plate.

Elastic energy can be stored in the spring roller as the shade is pulled out from the cassette to retract the shade into the cassette.

The spring roller can comprise a catch that holds the shade in an extended position.

The mounting panel can have a mounting slot extending from one open end of the cassette to the other open end. The vehicle can comprise a mounting protrusion slidably received in the mounting slot to fix the tire shade assembly to the vehicle.

Other aspects of the present disclosure include a tire shade assembly or a tire awning assembly for a tire on a vehicle, comprising a cassette having a mounting panel, a bottom panel connected to the mounting panel, and a cover panel connected to the mounting panel and the bottom panel, a tube received in the cassette, a shade wound around the tube having a free end extending out the bottom panel of the cassette in a deployed position to provide shade from UV rays, and a weight coupled to the free end of the shade and abutting against the bottom panel in a retracted position.

The free end can have a shade rod receptacle, and a shade rod is received in the free end.

A swivel cover can couple the shade to the weight.

One or more brushes can be received in the cassette. The brush can comprise bristles pressing against the shade to shield inside the cassette from debris.

End plates can be attached to open ends of the cassette to secure the shade, the tube, and the brushes located with the cassette.

A motor and a motor adaptor can be received in a bore of the tube and a battery pack electrically connected to the motor.

The motor can comprise a motor head fixed relative to the cassette and the motor adapter is rotatable relative to the motor head.

The motor head can be fixed to an interior surface of one of the end plates.

The interior surface of the one of the end plates can have a recess that is sized and shaped to receive the motor head and the motor head being received in the recess.

Fasteners can extend through holes in one of the end plates and engage the motor head to fix the motor to the end plate.

A power source from the vehicle and/or the sun through solar power can charge the battery pack and power the motor.

The shade can be extended out from the cassette by gravity acting on the weight, with the tube rotating in an unwinding direction as the shade is withdrawn from the cassette.

The motor can rotate the tube in a winding direction, the winding direction being opposite the unwinding direction.

A spring roller can be received in a bore of the tube, the spring roller comprising a housing fixed to the bore and a pin rotatably coupled to the housing and fixed to the cassette.

The pin can be fixed to one of the end plates.

One of the end plates can have a spring adjustment plate and a protrusion extending from a center of the spring adjustment plate engaging the pin to fix the pin to the spring adjustment plate.

The pin can be rectangular shaped and the protrusion can have a rectangular shaped recess receiving the pin.

The spring adjustment plate can have a ridged circumference corresponding to a ridged structure on the end plate to fix the spring adjustment plate to the end plate.

Elastic energy can be stored in the spring roller as the shade is pulled out from the cassette, the elastic energy being stored energy to retract the shade into the cassette.

The spring roller can comprise a catch that holds the shade in an extended position.

The mounting panel can have a mounting slot extending from one open end of the cassette to the other open end.

The vehicle can comprise a mounting protrusion slidably received in the mounting slot to fix the tire shade assembly to the vehicle.

Another aspect of the present disclosure includes a method of forming a tire shade assembly for covering a tire of a vehicle. The method can comprise: providing a cassette having opposite open ends, the cassette comprising a mounting panel, a bottom panel connected to the mounting panel, and a cover panel connected between the bottom panel and the mounting panel; sliding a shade wound around a tube into a shade chamber of the cassette, and sliding a brush assembly into a brush chamber; coupling a bottom plate to a free end of the shade; and attaching end plates to the open ends of the cassette.

Another aspect of the present disclosure includes a method of covering one or more tires of a vehicle. The method can comprise providing a cassette having opposite open ends, the cassette comprising a mounting panel, a bottom panel connected to the mounting panel, a cover panel connected between the bottom panel and the mounting panel, a shade wound around a tube received in a shade chamber of the cassette for covering a tire, a brush assembly received in a brush chamber of the cassette, a bottom plate coupled to a free end of the shade, and end plates attached to the open ends of the cassette. The method can further comprise extending the shade out of the cassette through a cassette opening of the bottom panel by rotating the tube in an unwinding direction.

The method can further comprise retracting the shade into the cassette by rotating the tube in a winding direction using a motor coupled between the cassette and the tube, the winding direction being opposite the unwinding direction.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a perspective view of a tire awning assembly or tire shade assembly provided in accordance with aspects of the present disclosure shown without an end cap for clarity;

FIG. 1A is a cross-sectional view of a mounting protrusion in accordance with aspects of the present disclosure.

FIG. 1B is a cross-sectional view of a mounting protrusion in accordance with further aspects of the present disclosure.

FIG. 2 is an exploded perspective view of the tire awning assembly of FIG. 1;

FIGS. 3A-3C illustrate progressive stages in assembly of a motorized tire awning assembly provided in accordance with aspects of the present disclosure;

FIGS. 4A-4C illustrate progressive stages in assembly of a manually operated tire awning assembly provided in accordance with aspects of the present disclosure;

FIG. 5 is a perspective view of the tire awning assembly at a deployed state; and

FIG. 6 is a perspective view of the tire awning assembly mounted on a vehicle.

### DETAILED DESCRIPTION

The detailed description set forth below in connection with the appended drawings is intended as a description of the presently preferred embodiments of tire awning assemblies provided in accordance with aspects of the present assemblies, systems, and methods and is not intended to represent the only forms in which the present devices, systems, and methods may be constructed or utilized. The description sets forth the features and the steps for constructing and using embodiments of the present assemblies, systems, and methods in connection with the illustrated embodiments. It is to be understood, however, that the same or equivalent functions and structures may be accomplished by different embodiments that are also intended to be encompassed within the scope of the present disclosure. As denoted elsewhere herein, like element numbers are intended to indicate like or similar elements or features.

In the following description, numerous specific details are set forth to provide a more thorough description of the invention. It will be apparent, however, to one skilled in the pertinent art, that the invention may be practiced without all of these specific details. In other instances, well known features have not been described in detail so as not to obscure the invention. The claims following this description are what define the metes and bounds of the invention.

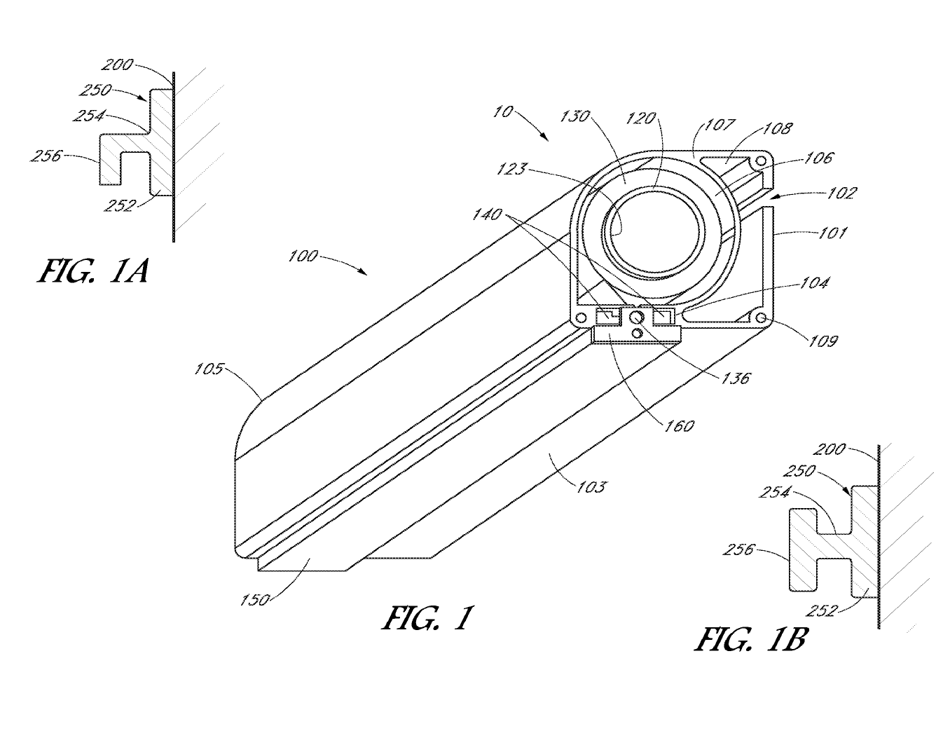

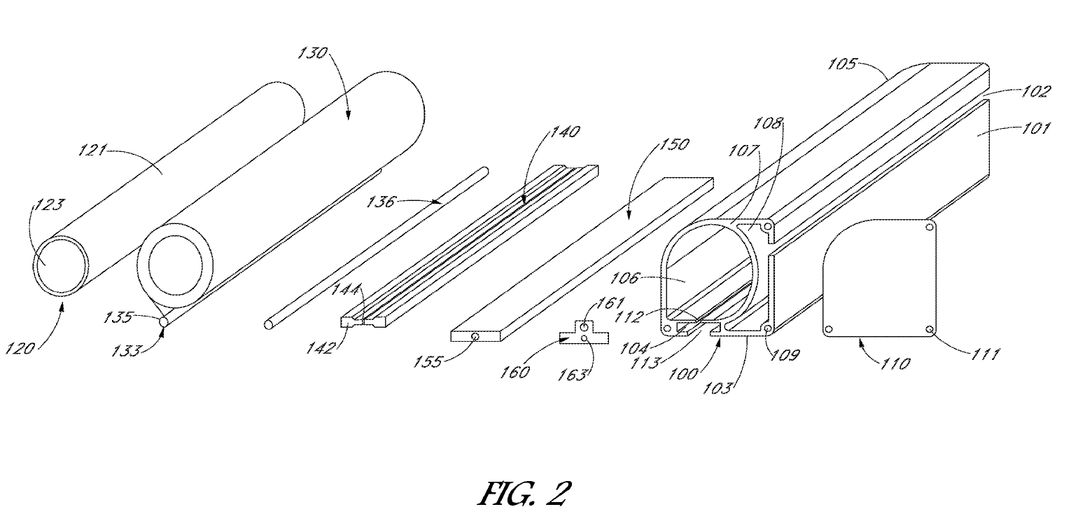

With reference now to FIG. 1, a tire awning assembly or tire shade assembly 10 provided in accordance with aspects of the present disclosure is shown in a retracted position. The tire awning assembly 10 includes a housing or cassette 100 with opposite open ends 107. One or more brushes 140, a tube 120, and a shade 130 wound around the tube 120 are slidably inserted into the cassette 100 from one of the open ends 107. The brushes 140 are configured to brush dust or debris from the shade 130 as the shade expands and rolls around the tube 120. A pair of end plates or caps 110 (FIG. 2) attached to the open ends 107 completes closure of the cassette 100 and secures the shade 130, the tube 120, and the pair of brushes 140 inside the cassette 100.

Attached to a free end of the shade 130 is a shade rod 136, which is coupled to a weight or bottom plate 150 by a swivel cover 160, which is attachable to an end of the bottom plate 150, as shown in their separated positions in FIG. 2. There can be two swivel covers 160 on each end of the bottom plate 150. The bottom plate 150 is pressed against or adjacent to a bottom panel 103 of the cassette 100 in the retracted position with the swivel cover 160 partially extended into the debris brush chamber 104. Components of the tire awning assembly 100 will be discussed in further detail below.

Turning now to FIG. 2, the cassette 100 has a mounting panel 101 adjacent to and connected to the bottom panel 103, and a cover panel 105 connected between the mounting panel 101 and the bottom panel 103. As shown, the cassette 100 has a long and slender hollow shape, but other shapes are contemplated to accommodate various mounting surfaces of the vehicle 200. The cassette 100 may be made of a durable lightweight material such as a hard plastic or a metal such as aluminum. In an example, the cassette 100 is made from extruded aluminum. The cassette 100 is structured to withstand moisture and debris striking the cassette 100 when the vehicle is moving or parked. Thus, the tire awning assembly 10 may operate in all weather conditions. Three separate chambers may be formed inside the cassette 100 including a shade chamber 106, a brush chamber 104 between the shade chamber 106 and the bottom panel 103, and a mounting chamber 108 between the shade chamber 106 and the mounting panel 101. The shade 130 and the tube 120 are received in the shade chamber 106, and the brushes 140 are received in the brush chamber 104. The open ends 107 of the cassette 100 may have a plurality of attachment holes 112 to receive fasteners passing through holes 111 of the end plates 100 to fasten the end plates 110 to the cassette 100. In one example, the attachment holes 112 at each open end 107 may be tapped holes or fitted with inserts to receive the fasteners. In another example, the holes 112 may be female detents to receive male detents extending from the end plates 110.

A mounting slot 102 extends longitudinally across the mounting panel 101 into the mounting chamber 108 from one open end 107 towards the other open end 107 providing access to the mounting chamber 108. The mounting chamber 108 may be isolated from the shade chamber 106 and the brush chamber 104 to prevent or limit debris and moisture that may enter through the mounting slot 102 into the mounting chamber 108 from entering the other chambers. With reference to FIGS. 1A and 1B, a mounting protrusion 250 extending from a vehicle 200 may slide inside the mounting chamber 108 along the mounting slot 102 from one open end 107 to support and fix the tire awning assembly 10 to the vehicle. In one example, the mounting protrusion 250 can be an L-shaped (FIG. 1A) or a T-shaped (FIG. 1B) protrusion extending from a bracket 252 mounted on the side of the vehicle 200. The T-shaped or L-shaped protrusion has a center portion 254 extending from the bracket 252 through the mounting slot 102 and a cross member 256 extending transversely from the center portion 254. In other examples, a coupling clip or channel may join the cassette to the vehicle without or in addition to a male projection and slot type attachment.

The tire awning assembly 10 may be assembled to the vehicle 200 by sliding the mounting protrusion 250 through one open end 107. The center portion 254 can slide along in the mounting slot 102 and the cross member 256 can slide inside the mounting chamber 108 and engage with one or more interior surfaces of the mounting panel 101. Any gaps between the center portion 254 and the mounting slot 102 and/or between the cross member 256 and the interior surface of the mounting panel 101 can be minimized to prevent the tire awning assembly 10 from rattling and shifting when mounted to the vehicle 200. Springs, Belleville washers, or spring washers may be used throughout the assembly to ensure adequate biasing and loading to minimize or prevent rattling and loosening. In one example, the mounting protrusion 250 may form a seal with the mounting slot 102. With the mounting protrusion 250 fully engaged with the mounting panel 101, the end plates 110 are attached to the open ends 107 to capture the mounting protrusion 250 inside the mounting chamber 108 and the mounting slot 102. The length of the mounting protrusion 250 may also be as long as the mounting slot 102 to prevent side by side movement between the tire awning assembly 10 and the mounting protrusion 250. The tire awning assembly 10 may also be attached to the vehicle 200 by other attachment means. In one such example, the tire awning assembly 10 may be attached to the surface of a vehicle 200 using magnets positioned in the mounting chamber 108 to magnetically attach to the sheet metal of the vehicle 200. In other examples, the magnets can be located on the vehicle 200, or both the mounting chamber and vehicle and can be assisted with fasteners.

Referring again to the cassette 100, the bottom panel 103 is adjacent to and substantially perpendicular to the mounting panel 101. A longitudinal slit 112 extends between the shade chamber 106 and the brush chamber 104 from one open end 107 to the other open end 107. A cassette opening 113 extends longitudinally across the bottom panel 103 from one open end 107 towards the other open end 107 below the longitudinal slit 112. The shade 130 extends from the shade chamber 106 through the slit 112 into the debris brush chamber 104 and through the cassette opening 113 to exit the cassette 100. The cassette opening 113 and the slit 112 each have a width at least greater than a thickness of the shade 130 and a length at least greater than the width of the shade 130 so that the shade 130 may slide through the cassette opening 113 and the slit 112 without or with only minimal restrictions.

The brush chamber 104 houses and supports the pair of brushes 140, which can slide into the brush chamber 104 from one of the exposed ends 107 of the cassette 100. Each brush 140 comprises a base 142 and a plurality of bristles 144 extending from the base 142. The brush chamber 104 may be sized and shaped to retain and prevent the brushes 140 from jostling or moving around inside the debris brush chamber 104. A width of the brush 140 may be larger than the width of the cassette opening 113 to prevent the brush 140 from slipping out the cassette opening 113. In other words, a slight interference may be provided to ensure adequate retention of the brushes 140 within the chamber 104. Inside the brush chamber 104, the pair of brushes 140 are aligned between the cassette opening 113 and the slit 112 with the bristles 144 extending towards each other from the bases 142. The pair of brushes may also be integrally formed or attached together to form a single unit. The bristles 144 press against the shade 130 to remove debris, such as dirt and dust from, the shade 130 as the shade 130 is drawn up into the shade chamber 106 through the cassette opening 113 and the slit 112.

The shade 130 is wound around the tube 120 in a stowaway position. The shade 130 may be made of a flexible material to provide cover or shade for the tire. In one example, the shade 130 is made from acrylic or canvas. The material or construction of the shade 130 can block UV rays from penetrating through the shade 130 and onto the tire. In one example, the shade can block at least 50% of the UV rays from penetrating through the shade 130. A coating may also be applied to the shade 130 to increase the blocking effectiveness of the shade in blocking the sunlight and UV rays. The shade 130 has an attached end along a width of the shade 130 which is attached to an outer circumference 121 of the tube 120 by adhesive, tape, or other attachment means, such as threads. With the attached end attached to the outer circumference 121, the shade 130 is wrapped around the tube 120. The number of wraps around the tube 120 depends on a length of the shade 130 and the circumference of the tube 120. As shown, the tube 120 is cylindrical having a hollow bore 123. At a free or loose end 133 of the shade 130, a shade rod receptacle 135 accommodates the shade rod 136. The shade rod receptacle 135 can be formed by forming a small U-shaped bend and fastening or sewing the loose end 133 of the shade 130 back to another section of the shade 130 to create a loop sized for the shade rod 136 to slide and remain in place.

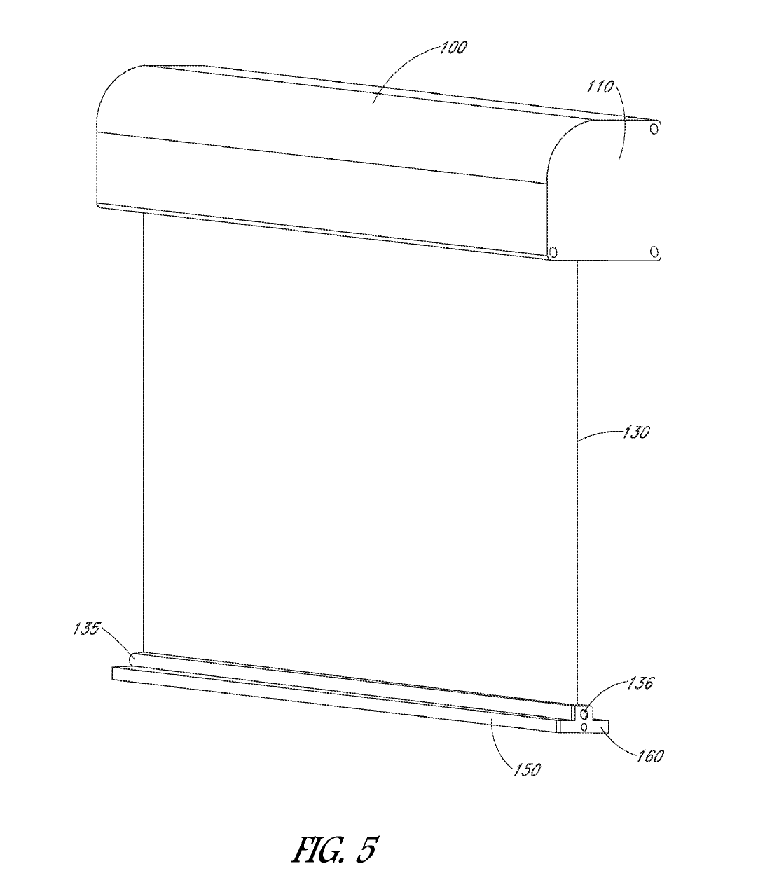

The tube 120 resides in the shade chamber 106 with the shade 130 extending through the slit 112 and between the bristles 144 of the pair of brushes 140. The shade rod 136 is received in the shade rod receptacle 135. As shown, the shade rod 136 is smaller than the width of the cassette opening 113 to allow the shade rod 136 to enter the brush chamber 104 through the cassette opening 113, but larger than the width of the slit 112 to prevent the shade rod 136 from entering the shade chamber 106 from the brush chamber 104. In another embodiment, the slit 112 is larger than the shade rod 136 so that the shade rod 136 can enter into the shade chamber 106. The shade rod 136 is coupled to the bottom plate 150 by the swivel cover 160. The swivel cover 160 has a first hole 161 to receive and secure the shade rod 136 to the swivel cover 160 and one or more second holes 163 that may be used to fix the swivel cover 160 to the bottom plate 150. For example, fasteners can extend through the second holes and engage the engagement holes 155 in the bottom plate 150 to attach the swivel cover to the bottom plate 150. The swivel cover 160 allows the bottom plate 150 to rotate with respect to the shade rod 126 for easy closure in the retracted position. With the bottom plate 150 coupled to the shade 130 through the swivel cover 160 and the shade rod 136, the bottom plate 150 provides the necessary weight heavy enough to pull or assist the shade 130 to unwind from the tube 120, thereby rotating the tube 120 in an unwinding direction, under the force of gravity to a deployed position (FIG. 5) or to an extended position between the retracted and deployed position.

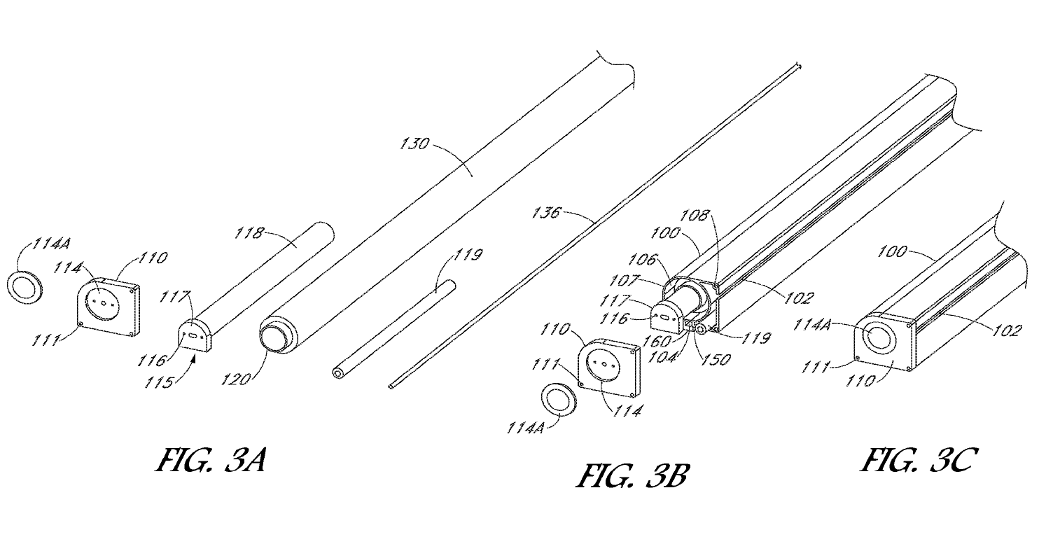

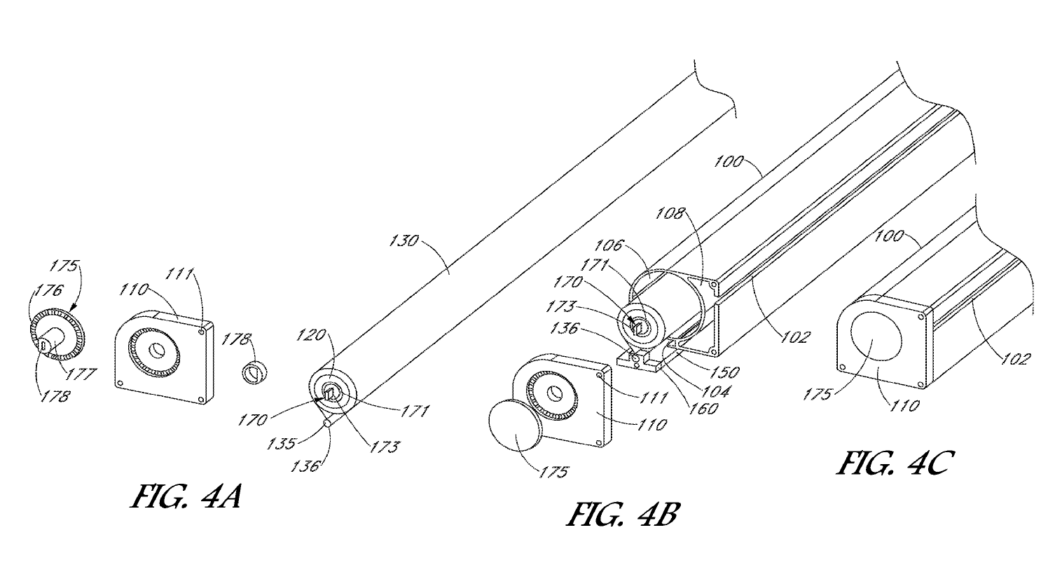

The shade 130 can cover or provide shade for one or more tires 210 of the vehicle 200 when in the extended position or deployed position. In some examples, the shade 130 is larger than a tire for a particular wheel well. In other examples, the shade is larger than the wheel well, at least along the width of the wheel well. The extension of the shade 130 outside the cassette 100 is controlled by rotation of the tube 120 of which the shade 130 is attached. For example, the shade 130 may be drawn up or retracted into the cassette 100 by rotation of the tube 120 inside the shade chamber 106 in a winding direction. The shade 130 may be drawn out of the cassette 100 by rotation of the tube 120 in an unwinding direction opposite the winding direction by the weight of the bottom plate 150 under gravity. The bottom plate 150 can also act as a handle to manually pull the shade 130 to unwind the shade 130 from the tube 120 to the extended or deployed position. A motor 115 may also be used to deploy the shade 130, as will be discussed further below with respect to FIGS. 3A-3C. To return the tire awning assembly 100 to the retracted or stowaway position, the shade 130 is rolled back up into the cassette 100 by rotating the tube 120 in the winding direction until the bottom plate 150 is pressed against the bottom panel 103 thereby covering the cassette opening 113. This can be accomplished by the motor 115 or a spring roller 170, which will be discussed below with respect to FIGS. 4A-4C.

The bottom plate 150 can form a seal against the cassette opening 113 to prevent dust, debris, or moisture from entering the brush chamber 104 in the retracted position. The bottom plate may be a flat plate 150 with enough mass to pull the shade 130 and unwind the tube 120 under the force of gravity. However, the weight can be less than that and additional pulling or tugging by a user can further unwind the shade 130. The shade rod 136 can seat against the slit 112 and form a seal between the slit 112 in the retracted position. With the tube 120, the shade 130, and the brushes 140 in the cassette 100, the end plates 110 may now be attached to the open ends 107 of the cassette 100 to secure the components in the cassette 100. Additional components may be added or substituted in the tire awning assembly 10 such as components for a motorized tire awning assembly shown in FIGS. 3A-3C and a non-motorized tire awning assembly as illustrated in FIGS. 4A-4C.

FIGS. 3A-3C illustrate various stages of assembling one embodiment of a motorized tire awning assembly 10. With reference now to FIGS. 3A and 3B, the tire awning assembly 10 comprises a cassette 100, a tube 120, shade 130 wound around the tube 120, a motor 115 coupled to the tube 120, a battery 119 electrically connected to the motor, a shade rod 136 attached to a free end of the shade 130, a bottom plate 150 coupled to the shade rod 136 by a swivel cover 160, a pair of brushes received in a brush chamber of the cassette 100, and a pair of end caps 110.

The motor 115 comprises a motor head 117 anchored to the cassette 100, at or near one of the ends that can be designated as a motor bracket. The motor 115 has a rotatable shaft and a motor adapter 118 connected to the shaft to be rotatable thereby and relative to the motor head 117. The motor can be a conventional AC or DC powered motor with sufficient horse power and torque to rotate the tube 120 to rotate the shade 130. The battery 119 may be received inside the bore 123 or disposed in the mounting chamber 108. The motor adapter 118 is fitted inside the bore 123 of the tube 120 to rotate the tube 120 when the motor 115 is activated. The motor 115 can be operated remotely or the cassette can be equipped with a controller and switch locally to activate the motor. The motor adapter 118 may be press fitted inside the bore 123 and/or aligned with a key (not shown) such as protrusions or grooves of the bore 123 engaging with complementing grooves and protrusions of the motor adapter 118 to control rotation of the tube 120 in the winding direction and/or the unwinding direction opposite the winding direction. The motor adapter 118 and the bore 123 may also incorporate gears so that the motor adaptor can rotate the tube 120 through gearing. A roller or guide may be fitted onto the opposite side of the tube 120 to align the tube 120 in the shade chamber 106 and allow the tube 120 to rotate freely in either direction.

The motor 115 can draw power from the vehicle battery, such as 12 VDC, or an external or separate battery 119 housed within the cassette 100 and electrically connected to the motor 115. The battery 119 may also be a rechargeable battery electrically connected to both the vehicle battery to recharge the battery 119 while supplying power to the motor 115. The battery may also optionally be charged by photocells, which can be mounted somewhere external of the vehicle, such as on the roof thereof. In one example, the power requirement of the motor 115 is about 6.7 Watts which would draw of about 0.6 Amps with a retraction speed of about 34 rpm. Before the motor 115 can be activated to rotate the tube 120, the motor head 117 should be anchored to the cassette 100 so that the motor adapter 118 can rotate relative to the motor head 117. The motor head 117 may have a non-circular shape matching a similar shaped cutout (not shown) in an internal surface of the end cap 110 to receive the motor head 117, thereby anchoring the motor head 117 to the end cap 110. The non-circular shapes of the motor head and cutout in the cap provide interference from rotation. Because the end cap 100 is fixed to the open end 107 of the cassette 100, the motor head 117 is also deemed fixed to the cassette 100. The motor head 117 can be securely fastened to the end cap 110 by securing fasteners extending through the end cap 110 and engaging with tapped holes or inserts 116 in the motor head 117. The end cap or end plate 110 may further include a pocket 114 at an external surface of the end cap 110 so that screw heads or nuts for threading to the securing fasteners, such as to threaded float rods or threaded rods, to secure the motor head 117 of the motor to the end cap 110 can reside inside the pocket 114. A hiding cover or finishing cover 114A can then be attached to the external of the end cap 110 over the pocket 114 to hide the heads or nuts and present a smooth and/or aesthetic appearance, as shown in FIG. 3C.

When the motor 115 is activated, the motor adapter 118 is configured to rotate the tube 120 in the winding direction to wrap the shade 130 around the tube 120, thereby drawing the shade 130 into the cassette from an extended or fully deployed position. The motor 115 can be controlled remotely or directly on the tire awning assembly 10 by a switch, such as a remote wall switch or key, or a switch or key directly on the tire awning assembly 10. Once a desired position is reached, such as in the retracted position, power to the motor 115 can be cut. After power to the motor 115 is cut, brakes on the motor 115 may hold the tube 120 in any position thereby preventing the tube 120 from rotating in the unwinding direction from the weight of the bottom plate 150 under gravity. Thus, the length of shade 130 exposed from the cassette 100 can be controlled by operation of the motor 115.

To extend the shade 130, the motor brakes can be released to allow the tube 120 to rotate in the unwinding direction and the shade 130 to deploy from the cassette 100 to the desired position by the weight of the bottom plate 150. The motor 115 may also rotate the tube 120 in the unwinding direction to unroll the shade 130 from the tube 120 in addition to the weight of the bottom plate 150. Thus, the length of shade 130 deployed from the cassette 100 may be adjusted by operation of the motor 115 in both the winding and unwinding directions until the desired length is obtained.

FIGS. 4A-4C illustrate various stages of assembling one embodiment of a non-motorized tire awning assembly 10. With reference initially to FIGS. 4A and 4B, the tire awning assembly 10 as shown comprises a cassette 100, a tube 120, a shade 130 wound around the tube 120, a spring roller 170 fitted inside a bore 123 of the tube 120, a spring adjustment plate 175, a bushing 178, a shade rod 136 attached to a free end of the shade 130, a bottom plate 150 coupled to the shade rod 136 by a swivel cover 160, a pair of brushes 140 comprising bristles received in a brush chamber of the cassette 100, and a pair of end caps 110 attached to the cassette 100.

The spring roller 170 comprises a housing 171 and a pin 173 is rotatably coupled to the housing 171. The housing 171 is fixed in the bore 123 of the tube 120 by interference fit and/or aligned with a key (not shown), such as protrusions or grooves of the bore 123 engaging complementing grooves and protrusions of the housing 171. The spring roller 170 mechanism operates by rotation of the housing 171 with respect to the pin 173. When either the pin 173 or the housing 171 rotates with respect to the other, a spring inside the spring roller 170 is also rotated and becomes continuously tighter as the rotation continues. Said differently, as the housing 171 rotates relative to the pin 173, elastic energy is stored within the spring to rotate the housing back from where it was rotated. Also located within the spring roller 170 is a catch mechanism that can hold the spring during the rotation.

Before the spring roller 170 can rotate the tube 120, the pin 173 must be anchored to the cassette 100. In the example shown, the spring adjustment plate 175 has a ridged circumference 176 and a protrusion 177 extending from a center of the adjustment plate 175. The pin 173 has a noncircular shape engaging a similarly shaped receptacle 178 in the protrusion 177 to prevent the pin 173 from rotating with respect to the spring adjustment plate 175. As shown, the pin 173 is flat or rectangular and engages a rectangular receptacle 178 in the protrusion 177. The ridged circumference 176 engages a complementing circular ridge 110A formed in the end plate 110. The ridged circumference 176 allows the spring adjustment plate 175 to be rotated at various angles to accommodate the angle of the pin 173, which is to engage in the receptacle 178. For example, if the rectangular pin 173 is at a 45 degree angle with respect to the bottom panel 103, then the adjustment plate 175 may be rotated along the ridged circumference 176 until the angle of the receptacle 178 is also at a 45 degree angle with respect to the bottom panel 103. A greater number of ridges of the ridged circumference 176 allows for a finer adjustment. In some examples, the spring adjustment plate 175 may not have a ridged circumference 176 but is directly fixed to the end plate 110 to anchor the pin 173 to the end plate 110. The protrusion 177 may also be noncircular and engage the bushing 178 having a matching noncircular bore to receive the protrusion 177. This allows the busing 178 to rotate with the protrusion 177 and stay attached to the protrusion 177. The protrusion 177 extends through a through hole in the end plate 100 and the bushing 178 until the pin 173 engages the receptacle 178, thereby anchoring the pin 173 to the end plate 110 which is fixed to the cassette 100.

The shade 130 of the non-motorized tire awning assembly 10 may be deployed by a user grasping the bottom plate 150 and pulling the shade 130 out from the cassette 100, thereby rotating the tube 120 and the housing 171 in the unwinding direction. When the tube 120 is rotated, the housing 171 is rotated to generate elastic energy stored in the spring. The more the tube 120 rotates in the unwinding direction, the greater the elastic energy is stored to rotate the tube in the winding direction. The user may pull the shade 130 from a retracted position to a fully deployed position or a position between the retracted to the fully deployed position. When the desired position is obtained, the user can release the bottom plate 150 and a catch mechanism inside the spring roller 170 will maintain the shade at the desired position. If the user wants to retract the shade 130 slightly or back to the retracted position, the user can tug on the bottom plate 150, which will release the catch mechanism and the elastic energy stored in the spring causing the tube 120 to rotate in the winding direction and drawing the shade 130 into the cassette 100.

With reference to FIG. 5, the tire awning assembly 10 is shown in the deployed position. As previously described, the bottom plate 150 may act as a weight to maintain the shade 130 at an extended position and ensure the shade 130 is stretched to provide maximum shade.

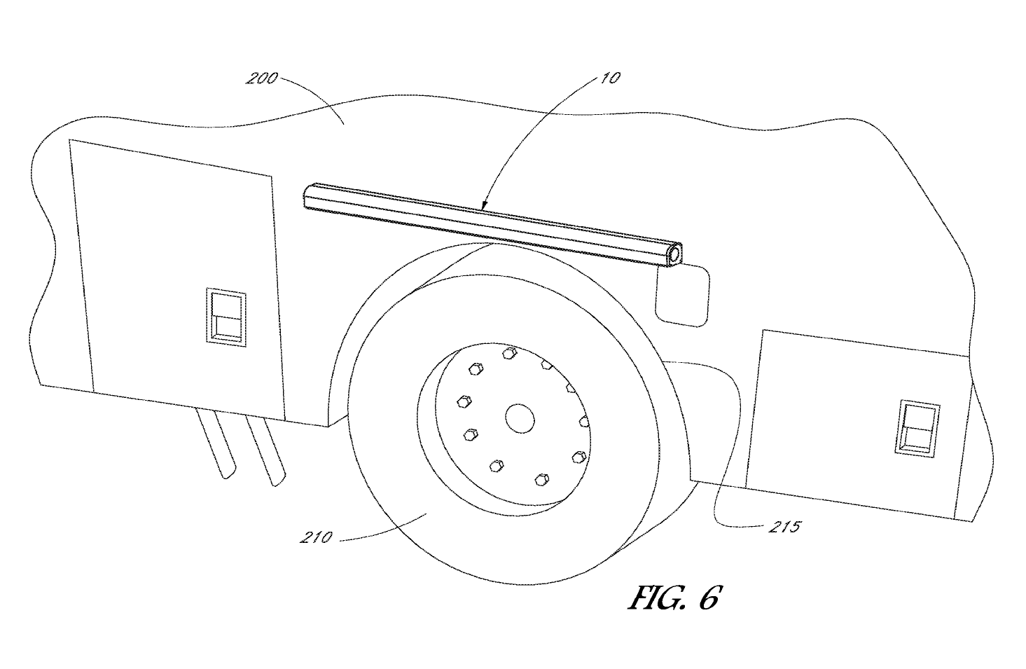

With reference to FIG. 6, the tire awning assembly 10 is shown mounted on a recreational vehicle 200 above the tire wheel well 215. However, the awning assembly 10 may be mounted on any wheeled vehicle to provide shades to any wheel well. The tire awning assembly 10 may be permanently or detachably mounted to the vehicle 200 to provide cover for one or more tires 210 of the vehicle 200 from UV ray exposure when the vehicle 200 is parked.

The tire awning assembly 10 can be mounted anywhere above the tire 210 such as inside or above the wheel well 215 of the vehicle 200. In one embodiment, the tire awning assembly 10 is mounted above the wheel well 215 and the tire 210 on an outer surface of the vehicle 200. In another embodiment, the tire awning assembly 10 is mounted above the wheel well 215 and the tire 210 on an inside a surface of the vehicle 200 with only a portion of the tire awning assembly 10 exposed. The tire awning assembly 10 can be operated manually or motor operated, remotely, wirelessly, or directly. The size of the tire awning 10 can vary depending on how many tires 210 the tire awning assembly 10 is to shield and the width of the wheel well. In one example, the tire awning assembly 10 is about 48 inches long, about 3 inches wide, and about 2.5 inches tall in a closed state. In an extended state, the height of the tire awning assembly 10 including the height of the cassette 100 and the length of the drawn out shade 130 can be about 48 inches tall. However, the size of the tire awning assembly 10 is not limited and may change according to a size of the tire and the number of tires the tire awning assembly 10 will cover and the dimensions provided are exemplary only.

Methods of making and of using the tire awning assemblies and their components discussed elsewhere herein are understood to fall within the scope of the present disclosure.

Although limited embodiments of tire awnings and their components have been specifically described and illustrated herein, many modifications and variations will be apparent to those skilled in the art. For example, the various cassettes, end caps, motors, and shade materials may differ than as described while still serves the purpose of providing shade for a vehicle's tires. Furthermore, it is understood and contemplated that features specifically discussed for one awning assembly embodiment may be adopted for inclusion with another awning assembly embodiment, provided the functions are compatible. Accordingly, it is to be understood that the tire awning assemblies and their components constructed according to principles of the disclosed device, system, and method may be embodied other than as specifically described herein. The disclosure is also defined in the following claims.

1. A tire shade assembly for a tire on a vehicle, comprising:
a cassette having a mounting panel, a bottom panel connected to the mounting panel, and a cover panel connected to the mounting panel and the bottom panel;
a tube received in the cassette;
a shade wound around the tube having a free end extending out the bottom panel of the cassette in a deployed position to provide shade from UV rays; and
a weight coupled to the free end of the shade and abutting against the bottom panel in a retracted position.

2. The tire shade assembly of claim 1, wherein the free end has a shade rod receptacle, and a shade rod is received in the free end.

3. The tire shade assembly of claim 1, further comprising a swivel cover coupling the shade to the weight.

4. The tire shade assembly of claim 1, further comprising a pair of brushes received in the cassette, each pair of brushes comprising bristles pressing against the shade to shield inside the cassette from debris.

5. The tire shade assembly of claim 1, further comprising a motor and a motor adaptor received in a bore of the tube and a battery electrically connected to the motor.

6. The tire shade assembly of claim 5, wherein the motor comprises a motor head fixed relative to the cassette and the motor adapter is rotatable relative to the motor head.

7. The tire shade assembly of claim 6, wherein the motor head is fixed to an interior surface of one of the end plates, and the interior surface of the one of the end plates has a recess that is sized and shaped to receive the motor head and the motor head being received in the recess.

8. The tire shade assembly of any of claim 5, wherein a power source from the vehicle charges the battery and powers the motor.

9. The tire shade assembly of claim 5, wherein the shade is extended out from the cassette by gravity acting on the weight, the tube rotating in an unwinding direction as the shade is withdrawn from the cassette, the motor rotates the tube in a winding direction, the winding direction being opposite the unwinding direction.

10. The tire shade assembly of any of claim 5, further comprising a spring roller received in the bore of the tube, the spring roller comprising a housing fixed to the bore and a pin rotatably coupled to the housing and fixed to the cassette.

11. The tire shade assembly of claim 10, wherein the pin is fixed to one of the end plates, the one of the end plates has a spring adjustment plate and a protrusion extending from a center of the spring adjustment plate engaging the pin to fix the pin to the spring adjustment plate.

12. The tire shade assembly of claim 10, wherein elastic energy is stored in the spring roller as the shade is pulled out from the cassette, the elastic energy being stored energy to retract the shade into the cassette.

13. The tire shade assembly of claim 10, wherein the spring roller comprises a catch that holds the shade in an extended position.

14. A method of covering one or more tires of a vehicle, the method comprising:
providing a cassette having opposite open ends, the cassette comprising a mounting panel, a bottom panel connected to the mounting panel, a cover panel connected between the bottom panel and the mounting panel, a shade wound around a tube received in a shade chamber of the cassette for covering a tire, a brush assembly received in a brush chamber of the cassette, a bottom plate coupled to a free end of the shade, and end plates attached to the open ends of the cassette; and
extending the shade out of the cassette through a cassette opening of the bottom panel by rotating the tube in an unwinding direction.

15. The method of claim 14, further comprising retracting the shade into the cassette by rotating the tube in a winding direction using a motor coupled between the cassette and the tube, the winding direction being opposite the unwinding direction.
